(19) United States
(12) Patent Application Publication
(10) Pub. No.: US 2014/0272844 A1
(43) Pub. Date: Sep. 18, 2014

(54) METHOD FOR INCREASING THE LIKELIHOOD TO INDUCE BEHAVIOR CHANGE IN A LIFESTYLE MANAGEMENT PROGRAM

(71) Applicant: KONINKLIJKE PHILIPS N.V., Eindhoven (NL)

(72) Inventors: MONIQUE HENDRIKS, Eindhoven (NL); AART VAN HALTEREN, Geldrop (NL); LU WANG, Eindhoven (NL)

(73) Assignee: KONINKLIJKE PHILIPS N.V., Eindhoven (NL)

(21) Appl. No.: 14/202,796

(22) Filed: Mar. 10, 2014

Related U.S. Application Data
(60) Provisional application No. 61/789,768, filed on Mar. 15, 2013.

(51) Int. Cl. G09B 5/00

(52) U.S. Cl. CPC G09B 5/00
USPC 434/236

(57) ABSTRACT

A method and corresponding system for increasing the likelihood of inducing behavior change in a lifestyle management program for a user includes sensing at least one behavior parameter of a user; identifying at least one intention-behavior gap based on the sensing of the behavior parameter; via application of a genetic algorithm generating a quantified profile of the intention-behavior gap; via a user interface, suggesting at least one action to accept or reject; and varying the quantified profile based on the action accepted or rejected by the user. The user interface may include a smart phone that includes at least one sensor for sensing location and activity of a user of the user interface, or a dedicated device that communicates with a sensor for sensing a behavior parameter, or the sensor is disposed on the body of the user or on a garment worn by the user.

### BACKGROUND

1. Technical Field

The present disclosure relates to the field of promoting a healthier lifestyle to a subject, and in particular to systems, methods and computer readable media for coaching purposeful interactions with a subject.

2. Description of Related Art

In the field of promoting a healthier lifestyle for a subject, research has indicated that the likelihood of obtaining a behavior change is increased through:

Coaching that is tailored to the individual (Lacroix et. al., 2009); Coaching that is tailored to the individual's current context (IJsselsteijn, 2006); and Using the most effective goal-setting strategy (Locke, 2002). Using research on persuasion strategies, context sensing and goal setting, a virtual coach can thus be constructed that has a high likelihood of being effective. However, what this coach is effective in, is in inducing an intention to behave in a certain way. Actual behavior change relies not only on this intention, but is also mediated by other factors.

Though intention is mostly considered to be the best predictor of behavior, a change of intention does not necessarily lead to a behavior change (Sheeran, 2002). The intention to act does not necessarily lead to the action actually being executed. This gap between intentions and behavior is called the intention-behavior gap. This intention-behavior gap is a major hurdle for making online (automated) coaching successful. As a result, only a fraction of the participants (usually between 25% and 30%) actually change their behavior.

Several factors mediate the size of the intention-behavior gap. Sheeran (Sheeran, 2002) provides an overview of research into these mediating factors. Table 1 herein provides a list of factors that influence whether intention leads to actions and a description of their influence (Sheeran, 2002).

Currently, automated coaching systems are successful at motivating people. Through persuasion and goal setting, they are able to induce an intention for behavior change. Through persuasion and goal setting, they are able to induce an intention for behavior change. Persuasion and goal setting are often tailored to the individual. Automated coaching systems instruct people through providing suggestions for behavior changing actions that are either completely random, or tailored to the user's context. Instructions are tailored to the individual only in the sense that an individual may provide preferences, or these preferences are detected through the number of times certain actions are executed.

Automated coaching systems provide insight only on the level of progress that is being made.

### SUMMARY

The embodiments of the present disclosure relate to an electronic coaching system and corresponding method for increasing the effectiveness of automated coaching on behavior change.

More particularly, in one exemplary embodiment of the present disclosure, a method for increasing the likelihood of inducing behavior change in a lifestyle management program for a user includes sensing at least one behavior parameter of a user; identifying at least one intention-behavior gap based on the sensing of the at least one behavior parameter; generating a quantified profile of the at least one intention-behavior gap of the user; via a user interface, suggesting to the user at least one action that the user can accept or reject; and varying the quantified profile based on the at least one action accepted or rejected by the user. The method may further include representing the quantified profile as a combination of properties as either an action or a context or a combination of an action and a context. the method may further include applying a genetic algorithm to run at least one generation of the genetic algorithm as genes wherein the timeslot and properties of the action are equivalent to the genes. The method may further include defining a fitness function as the size of the intention-behavior gap based on the quantified profile. The method may still further include defining a mutation as a change in a single gene by one of flipping the value of the single gene or by increasing the value of the single gene or by decreasing the value of the single gene or by choosing a random other value of the single gene.

Still further, the method may further include defining a maximum number of runs of the at least one run; and defining a stop criterion for the running of the at least one generation of the genetic algorithm as stopping the running when differences in the behavior-intention gap are less than or equal to a pre-determined value.

Yet further, the method may include, upon the differences in the behavior-intention gap being less than or equal to a pre-determined value, stopping the running of the at least one generation of the genetic algorithm; and returning the top actions of fittest individuals as suggestions to the user.

Additionally, the method may further include, upon the differences in the behavior-intention gap being greater than a pre-determined value, returning to the step of applying the genetic algorithm to run at least one generation of the genetic algorithm as genes wherein the timeslot and properties of the action are equivalent to the genes.

In yet another exemplary embodiment, wherein the user interface includes a smart phone that includes at least one sensor for sensing location and activity of a user of the user interface, the method includes sensing the at least one behavior parameter of the user via sensing the location and activity of the user via the smart phone; identifying at least one intention-behavior gap based on the sensing of the at least one behavior parameter; generating a quantified profile of the at least one intention-behavior gap of the user; via the smart phone, suggesting to the user at least one action that the user can accept or reject; and varying the quantified profile based on the at least one action accepted or rejected by the user.

In still another exemplary embodiment, wherein the user interface includes a dedicated device that includes at least one sensor for sensing behavior of a user of the user interface, the dedicated device in communication with and in synchronization with a computing resource, the method includes sensing the at least one behavior parameter of the user via sensing the behavior of the user via the dedicated device; identifying at least one intention-behavior gap based on the sensing of the at least one behavior parameter; generating a quantified profile of the at least one intention-behavior gap of the user; via the computing resource communicating with the dedicated device, suggesting to the user at least one action that the user can accept or reject; and varying the quantified profile based on the at least one action accepted or rejected by the user.

In a further exemplary embodiment, wherein the user interface includes a dedicated device that communicates with at least one sensor for sensing at least one behavior parameter of a user of the user interface, the at least one sensor disposed on the body of the user or on a garment worn by the user, the method includes sensing the at least one behavior parameter of the user via sensing the behavior of the user via the dedicated device and the at least one sensor; identifying at least one intention-behavior gap based on the sensing of the at least one behavior parameter; generating a quantified profile of the at least one intention-behavior gap of the user; via the dedicated device, suggesting to the user at least one action that the user can accept or reject; and varying the quantified profile based on the at least one action accepted or rejected by the user.

In yet another exemplary embodiment, the present disclosure relates to a system for increasing the likelihood of inducing behavior change in a lifestyle management program for a user including: a processor; and a memory storing instructions, executable by the processor, wherein the instructions when executed by the processor cause the system to: sense at least one behavior parameter of a user; identity at least one intention-behavior gap based on the sensing of the at least one behavior parameter; generate a quantified profile of the at least one intention-behavior gap of the user; via a user interface, suggest to the user at least one action that the user can accept or reject; and vary the quantified profile based on the at least one action accepted or rejected by the user.

The system may further include, wherein the instructions when executed by the processor further cause the system to: represent the quantified profile as a combination of properties as either an action or a context or a combination of an action and a context. The system may additionally include, wherein the instructions when executed by the processor further cause the system to: apply a genetic algorithm to run at least one generation of the genetic algorithm as genes wherein the timeslot and properties of the action are equivalent to the genes.

In one exemplary embodiment, the system may include, wherein the instructions when executed by the processor further cause the system to: define a fitness function as the size of the intention-behavior gap based on the quantified profile.

In still another exemplary embodiment, the system may include, wherein the instructions when executed by the processor further cause the system to: define a mutation as a change in a single gene by one of flipping the value of the single gene or by increasing the value of the single gene or by decreasing the value of the single gene or by choosing a random other value of the single gene.

Yet further, the system may include, wherein the instructions when executed by the processor further cause the system to: define a maximum number of runs of the at least one run; and define a stop criterion for the running of the at least one generation of the genetic algorithm as stopping the running when differences in the behavior-intention gap are less than or equal to a pre-determined value.

Still further, the system, wherein the instructions when executed by the processor further cause the system to: upon the differences in the behavior-intention gap being less than or equal to a pre-determined value, stop the running of the at least one generation of the genetic algorithm; and return the top actions of fittest individuals as suggestions to the user.

Additionally, the system may include, wherein the instructions when executed by the processor further cause the system to: upon the differences in the behavior-intention gap being greater than a pre-determined value, return to apply the genetic algorithm to run at least one generation of the genetic algorithm as genes wherein the timeslot and properties of the action are equivalent to the genes.

In still another exemplary embodiment of the present disclosure, the system may include, wherein the user interface includes a smart phone that includes at least one sensor for sensing location and activity of a user of the user interface, wherein the instructions when executed by the processor cause the system to: sense the at least one behavior parameter of the user via sensing the location and activity of the user via the smart phone; identify at least one intention-behavior gap based on the sensing of the at least one behavior parameter; generate a quantified profile of the at least one intention-behavior gap of the user; via the smart phone, suggest to the user at least one action that the user can accept or reject; and vary the quantified profile based on the at least one action accepted or rejected by the user.

In still a further exemplary embodiment of the present disclosure, the system may include, wherein the user interface comprises a dedicated device that includes at least one sensor for sensing behavior of a user of the user interface, the dedicated device in communication with and in synchronization with a computing resource, wherein the instructions when executed by the processor cause the system to: sense the at least one behavior parameter of the user via sensing the behavior of the user via the dedicated device; identify at least one intention-behavior gap based on the sensing of the at least one behavior parameter; generate a quantified profile of the at least one intention-behavior gap of the user; via the computing resource communicating with the dedicated device, suggest to the user at least one action that the user can accept or reject; and vary the quantified profile based on the at least one action accepted or rejected by the user.

In yet another exemplary embodiment of the present disclosure, the system may include, wherein the user interface includes a dedicated device that communicates with at least one sensor for sensing at least one behavior parameter of a user of the user interface, the at least one sensor disposed on the body of the user or on a garment worn by the user, wherein the instructions when executed by the processor cause the system to: sense the at least one behavior parameter of the user via sensing the behavior of the user via the dedicated device and the at least one sensor; identify at least one intention-behavior gap based on the sensing of the at least one behavior parameter; generate a quantified profile of the at least one intention-behavior gap of the user; via the dedicated device, suggest to the user at least one action that the user can accept or reject; and vary the quantified profile based on the at least one action accepted or rejected by the user.

In another exemplary embodiment of the present disclosure, the present disclosure relates to a non-transitory computer readable storage medium storing a program which, when executed by a computer, causes the computer to perform a method for increasing the likelihood of inducing behavior change in a lifestyle management program for a user, including sensing at least one behavior parameter of a user; identifying at least one intention-behavior gap based on the sensing of the at least one behavior parameter; generating a quantified profile of the at least one intention-behavior gap of the user; via a user interface, suggesting to the user at least one action that the user can accept or reject; and varying the quantified profile based on the at least one action accepted or rejected by the user.

In yet another exemplary embodiment of the present disclosure, the present disclosure relates to an apparatus for increasing the likelihood of inducing behavior change in a lifestyle management program for a user including: a processor; and a memory storing instructions, executable by the processor, wherein the instructions when executed by the processor cause the apparatus to: sense at least one behavior parameter of a user; identity at least one intention-behavior gap based on the sensing of the at least one behavior parameter; generate a quantified profile of the at least one intention-behavior gap of the user; via a user interface, suggest to the user at least one action that the user can accept or reject; and vary the quantified profile based on the at least one action accepted or rejected by the user.

The apparatus may include, wherein the instructions when executed by the processor further cause the apparatus to: represent the quantified profile as a combination of properties as either an action or a context or a combination of an action and a context.

The apparatus may further include, wherein the instructions when executed by the processor further cause the apparatus to: apply a genetic algorithm to run at least one generation of the genetic algorithm as genes wherein the timeslot and properties of the action are equivalent to the genes. The apparatus may still further include, wherein the instructions when executed by the processor further cause the apparatus to: define a fitness function as the size of the intention-behavior gap based on the quantified profile. Additionally, the apparatus may include, wherein the instructions when executed by the processor further cause the apparatus to: define a mutation as a change in a single gene by one of flipping the value of the single gene or by increasing the value of the single gene or by decreasing the value of the single gene or by choosing a random other value of the single gene.

Still further, the apparatus may include, wherein the instructions when executed by the processor further cause the apparatus to: define a maximum number of runs of the at least one run; and define a stop criterion for the running of the at least one generation of the genetic algorithm as stopping the running when differences in the behavior-intention gap are less than or equal to a pre-determined value.

Yet further, the apparatus may include, wherein the instructions when executed by the processor further cause the apparatus to: upon the differences in the behavior-intention gap being less than or equal to a pre-determined value, stop the running of the at least one generation of the genetic algorithm; and return the top actions of fittest individuals as suggestions to the user.

Additionally, the apparatus may include, wherein the instructions when executed by the processor further cause the apparatus to: upon the differences in the behavior-intention gap being greater than a pre-determined value, return to apply the genetic algorithm to run at least one generation of the genetic algorithm as genes wherein the timeslot and properties of the action are equivalent to the genes.

### BRIEF DESCRIPTION OF THE FIGURES

The aspects of the present disclosure may be better understood with reference to the following figures. The components in the figures are not necessarily to scale, emphasis instead being placed upon clearly illustrating the principles of the disclosure. Moreover, in the figures, like reference numerals designate corresponding parts throughout the several views.

In the figures:

FIG. 1 is a relationship block diagram illustrating the relationship of the mediating factors listed in TABLE 1 depend on the properties of the user, the user's context and the specific action;

FIG. 2 is a block diagram of an electronic coaching system from a user's perspective according to one embodiment of the present disclosure;

FIG. 3 is a schematic representation of components of the electronic coaching system of FIG. 2 and illustrates the cooperation of these components in accordance with an embodiment of the present disclosure;

FIG. 4A is a workflow diagram of the electronic coaching system of FIGS. 2 and 3;

FIG. 4B is a continuation of the workflow diagram of the electronic coaching system of FIG. 4A;

FIG. 5A is a flow chart for action suggestions of the electronic coaching system of FIGS. 2 and 3;

FIG. 5B is a continuation of the flow chart for action suggestions of the electronic coaching system of FIG. 4A;

FIG. 6 is a graphical plot a sigmoid squashing function for establishing a profile for a user of the electronic coaching system of FIGS. 2 and 3;

FIG. 7 illustrates an exemplary embodiment of an electronic calendar for increasing physical activity of the user according to one embodiment of the present disclosure;

FIG. 8 illustrates an exemplary embodiment of an electronic calendar for coaching a user regarding relief of stress according to one embodiment of the present disclosure;

FIG. 9 illustrates a visual display of a drop-down box for the electronic coaching system of FIGS. 2 and 3 according to one embodiment of the present disclosure;

FIG. 10 is an additional workflow diagram in conjunction with the drop-down box of FIG. 9;

FIG. 11 illustrates a visual display of another drop-down box for the electronic coaching system of FIG. 3 according to one embodiment of the present disclosure;

FIG. 12 is an additional workflow diagram in conjunction with the drop-down box of FIG. 11;

FIG. 13 illustrates a user carrying a smartphone that includes an accelerometer wherein the smartphone operatively communicates with a global positioning system;

FIG. 14 illustrates a dedicated device to measure user behavior connected to a personal computer; and

FIG. 15 illustrates a user who has a sensor to measure behavior integrated into a piece of clothing wherein a dedicated device contacts the sensor via near field communications (NFC) or Bluetooth.

### DETAILED DESCRIPTION

The embodiments of the present disclosure relate to an electronic coaching system and corresponding method for increasing the effectiveness of automated coaching on behavior change.

The embodiments of the present disclosure enable a method, and corresponding system, for increasing the effectiveness of automated coaching on behavior change. Coaching entails providing insight in behavior and personal barriers, motivating through goal setting and providing rewards and instructing through personalized guidance, actionable advice and support in difficult situations. Automated coaching should try to incorporate these properties of human coaching in order to be as effective as possible, while reducing the cost of personalized coaching. Most automated coaching methods provide motivation through goal setting and rewards. However, insight is only provided on the level of achievement, automated coaching methods do not provide indications of personal barriers. Furthermore, automated coaching methods provide personalized and actionable advice only in the sense that it can be adapted to certain personal settings that the user provides—to personalize the advice—and possibly through sensing the user's context—to make the advice actionable.

The embodiments of the present disclosure enable a method, and corresponding system, for addressing barriers and providing truly personalized, actionable advice. The method uses the notion of intention-behavior gap to provide suggestions for behavior changing actions with a high likelihood of effectiveness. This gap is modeled based on the mediating factors (Sheeran 2002). The factors are addressed in quantifiable variables. A sigmoid function may be used as an exemplary function to scale several values to the same order of magnitude. The function uses default values and triggers in order to minimize obtrusiveness. A genetic algorithm is then used to calculate the most opportune suggestions for actionable advice. Based on the user's reaction to these suggestions, actions are automatically planned in the user's agenda and values for the quantified intention-behavior gap are updated accordingly. Planned actions are monitored through the sensor or sensors used by the system. Whether a planned action is executed or not is a trigger for the system to update the values for the quantified intention-behavior gap accordingly and to suggest alternative actions. One or more sensors are used to measure the user's behavior (e.g. An activity monitor) and an electronic calendar is used to help the user to plan his or her behavior.

To understand the inventive features of the present disclosure, first it should be again noted that research has indicated that the likelihood of obtaining a behavior change is increased through:

Coaching that is tailored to the individual (Lacroix et. al., 2009);

Coaching that is tailored to the individual's current context (IJsselsteijn, 2006);

Using the most effective goal-setting strategy (Locke, 2002);

Using research on persuasion strategies, context sensing and goal setting, a virtual coach can thus be constructed that has a high likelihood of being effective. However, what this coach is effective in, is in inducing an intention to behave in a certain way. Actual behavior change relies not only on this intention, but is also mediated by other factors.

Though intention is mostly considered to be the best predictor of behavior, a change of intention does not necessarily lead to a behavior change (Sheeran, 2002). The intention to act does not necessarily lead to the action actually being executed. This gap between intentions and behavior is called the intention-behavior gap. This intention-behavior gap is a major hurdle for making online (automated) coaching successful. As a result, only a fraction of the participants (usually between 25% and 30%) actually change their behavior.

Several factors mediate the size of the intention-behavior gap. Sheeran (Sheeran, 2002) provides an overview of research into these mediating factors. TABLE 1 provides a list of factors that influence whether intention leads to actions and a description of their influence (Sheeran, 2002).

The advantages that the embodiments of the present disclosure retain from the current state of automated coaching are the following:

Low cost; and

Support throughout the day (as opposed to for example once a week, when using a human coach).

The advantages from human coaching that the embodiments of the present disclosure incorporate into automated coaching are:

An understanding of what makes it difficult for a particular individual to turn an intention into behavior.

Use of this understanding in making personalized suggestions for behavior changing actions.

Feedback to the user, to help the user obtain a similar understanding of what makes it difficult for him to turn an intention into behavior.

To create an understanding of what makes it difficult for a particular individual to turn an intention into behavior in order to use it to make personalized suggestions and to provide feedback to the user in an automated coaching system is not a trivial matter.

First of all, the factors that influence the intention behavior gap will need to be quantified. There is no direct means to measure the factors listed in TABLE 1. A mapping of these factors to a numeric value needs to be created. Furthermore, measurement of these factors should be as unobtrusive as possible. The system should require input from the user as little as possible.

As can be seen in FIG. 1, these factors depend on properties of the user, his or her context and the specific action. The number of possible contexts and the number of possible actions is very large. This further complicates the unobtrusive measurement of the factors influencing the intention-behavior gap. The number also renders the use of a simple machine learning algorithm to determine the most effective action suggestions ineffective. It will not be possible to approximate the most effective action suggestion through machine learning in a reasonable time frame, the user would have to use the system for a very long time, and provide it a large amount of input, before the system can make an effective personalized suggestion. Furthermore, such a machine learning algorithm can only provide feedback to the user regarding which weight was given to each possible action. The algorithm can not provide real insight into why this specific action suggestion is effective for the particular user.

TABLE 1
LIST OF FACTORS THAT MEDIATE THE INTENTION-BEHAVIOR GAP

| Mediating factor | Description | Influence |
|---|---|---|
| Type of behavior | Is it a single action or a goal | The intention-behavior |
| | (an outcome that can be | gap is smaller for single |
| | achieved by performing a | actions than for goals |
| | variety of single actions) | (The extent to which the |
| | | performance of particular |
| | | behaviors actually |
| | | controls whether or not a |
| | | goal will be achieved is |
| | | the critical factor.) |
| Actual and perceived | Do you have the knowledge, | The intention-behavior |
| behavioral control | ability, (mental) resources and | gap is smaller for action |
| | opportunity to execute the | over which you |
| | intention, is everything that | have/perceive to have |
| | you need to execute the | control |
| | intention available, do you | |
| | have the cooperation of | |
| | others that you need, are | |
| | there unexpected situations? | |
| Expectations | Are there factors that make | The intention-behavior |
| | you suspect that you may be | gap is smaller if you |
| | unsuccessful? | expect to be successful |
| Implementation intentions | Does your intention include a | Implementation intentions |
| | place and time and a | reduce the intention- |
| | description of how you intend | behavior gap compared to |
| | to execute the action? | intentions that do not |
| | | include the ‘when, where |
| | | and how’ |
| Temporal stability of | Intentions can change over | The intention-behavior |
| intentions | time. Between the time of | gap is smaller for |
| | formation of the intention X | intentions that have a |
| | and possible execution of X, | great temporal stability. |
| | intention X may have changed | |
| | to intention Y, preventing | |
| | execution of X | |
| Degree of intention formation | Thinking through the | A high degree of |
| | consequences of your | formation results in a |
| | decision to act, thereby | smaller intention-behavior |
| | foreseeing obstacles, | gap |
| | difficulties, disadvantages, | |
| | results in greater temporal | |
| | stability of the intention | |
| Attitudinally versus | Does the intention follow from | An attitudinally controlled |
| normatively controlled | an internal motivation, or is it | intention has a smaller |
| intentions | normatively determined for | intention-behavior gap |
| | example by societal norms | compared to a |
| | and values? | normatively controlled |
| | | intention |
| Confidence | The degree of confidence in | The more confident you |
| | your ability to execute the | are of your ability to |
| | intention | execute the intention, the |
| | | smaller the intention- |
| | | behavior gap |
| Accessibility | To what degree is the | The more accessible an |
| | intention ‘on your mind’? | intention is, the smaller |
| | Every time you think about an | the intention-behavior gap |
| | intention, it becomes more | |
| | readily accessible in memory | |
| Action oriented personality | Action oriented people have a | The intention-behavior |
| versus state oriented | greater tendency to focus on | gap is smaller for action |
| personality | the actions required to reduce | oriented people |
| | the gap between their current | |
| | state and the desired state, | |
| | while state oriented people | |
| | only focus on their current | |
| | state or the intended state. | |
| | Action oriented people are | |
| | therefore more flexible in | |
| | considering alternative ways | |
| | to reach a goal, state oriented | |
| | people are not able to | |
| | consider alternatives since | |
| | they only focus on one of the | |
| | two states. | |
| Anticipated regret | The degree of regret that you | The greater the |
| | think you will feel if you do not | anticipated regret, the |
| | execute the intention | smaller the intention- |
| | | behavior gap |
| Self-schemas | Do you consider yourself to | The more you feel that an |
| | be a person that would | intention, or the domain of |
| | typically have intention X? Do | an intention, is self- |
| | you think that X is important | descriptive of you and |
| | for you? | important for you, the |
| | | smaller the intention- |
| | | behavior gap |
| Conflicting intentions | Your intentions are conflicting | The less conflicting |
| | if executing one does not | intentions you have, the |
| | make the other impossible to | smaller the intention- |
| | execute, but does make it less | behavior gap |
| | likely to be executed | |

FIG. 1 is a relationship block diagram 100 in the form of a triangle that illustrates the dependency of the mediating factors described in TABLE 1 on the properties of the user, the context of the user, and the specific action. More particularly, a user 110 exhibits mediating factors (e.g., personal characteristics) 110′ such as degree of intention formation 110a, an action oriented versus state oriented personality 110b and temporal stability 110c.

The user 110 is influenced by the action 120 (the link between the user 110 and the action 120 forming first leg 1120 representing mediating factors of the triangle 100). The probability of the action 120 being implemented by the user 110 is dependent upon the type of action 120′

The mediating factors 1120 forming the intention-gap between the user 110 and the action 120 include self-schemas 1120a, confidence 1120b, accessibility 1120c, anticipated regret 1120d and behavioral control 1120e, the latter including knowledge and ability.

The user 110 is also influenced by the context 130 in which the action 120 must be undertaken (the link between the action 120 and the context 130 forming second leg 1230 representing mediating factors of the triangle 100). The probability of the action 120 being implemented by the user 110 is also dependent upon the mediating factors 1230 which include implementation intentions 1230a and behavioral control 1230b, the latter including (mental) resources, opportunity, availability of materials and cooperation.

The context 130 includes mediating factors 130′ that include behavioral control 130a that is influenced by unexpected situations.

The user 110 is influenced by the context 130 (the link between the user 110 and the context 130 forming third leg 1310 representing mediating factors of the triangle 100). The mediating factors 1310 include attitudinal versus normative factors. The result of the aforementioned influences on the user 110 and the mediating factors result in conflicting intentions and expectations 102.

Thus, FIG. 1 illustrates how the mediating factors 1310 are linked to properties of user 110, the context, the action, or any combination of those. Thus, if it is desired to obtain insight into the user's barriers (mediating factors) for transforming an intention into a behavior, the properties of the user must be taken into account, the context and the action (as opposed to e.g. only the user as is done in using preferences, or only the context as is done in systems that suggest actions based on e.g. your current location, etc.) So it is not e.g. the user who is influenced by the action [054], but it is list of mediating factors (barriers) 2210, which is influenced by properties of the user as well as properties of the action.

Conflicting intentions and expectations do not result from the other influences, but such conflicting intentions and expectations are the result of certain properties of the user, the action and the context. e.g. if the users has the intention to do sports, but also to watch television, then this conflicting intention to watch television exists because the user likes to watch television (user property), because something interesting might be on television (context property, the television guide) and because watching television is a simpler action to perform than doing sports (action property).

Referring to FIGS. 2 and 3, there is illustrated an electronic coaching system 200 according to embodiments of the present disclosure that implements the relationship block diagram 100 of mediating factors described above in FIG. 1 with respect to TABLE 1.

FIG. 2 provides a user's view of the system. As described in more detail below, the electronic coaching system 200 includes an electronic coach 202. The electronic coach 202 includes a computing resource 204. The computing resource 204 provides the following features to the user 110 and includes the following:

A profile unit 210 that provides a quantified profile 210′ of the intention-behavior gap, using the following:

Default values for unobtrusive initialization; and

A mathematical function such as, for example, the sigmoid function to scale every measure to the same order of magnitude.

Via a targeted questions unit 212, targeted questions 212′ to improve the profile 210′ by specific triggers to identify factors that possibly need to be updated/remeasured, so the user is only bothered by questions that have a high likelihood of improving the effectiveness of the system.

A behavior planning calendar unit 220 to generate a calendar 220′ for planning behavior changing actions so that the system can determine the following:

Whether the user's personal goal will be reached; and

Via a behavior sensor monitoring unit 230 and sensors 230′, monitoring whether planned actions have been executed (through measuring the behavior and keeping track of the current time).

A suggestions unit 214 that provides suggestions 214′ to the user 110 to represent behavior changing actions as a combination of properties, which enables the use of a genetic algorithm to find diverse actions that have a small intention-behavior gap, through the following:

Using timeslot and properties of the action as genes;

Defining the size of the gap (determined from the quantified profile) as the fitness function; and

Returning the top x of fittest individuals as suggestions to the user, that is, in the exemplary case disclosed herein, x varies from 1 to 5, and represents the best-fitting actions most probable to be implemented by the user. In other embodiments of the present disclosure, the value for x may be less than 5 or greater than 5 but less than some practical upper limit, for example, 10.

The electronic coaching system 200 uses goal setting strategies to collaboratively set a motivating goal for the user 110. The system 200 uses a sensor, or multiple sensors, 230′ in electrical communication with the behavior sensing monitoring unit 230 to monitor the user's behavior. The system 200 uses the electronic behavior planning calendar unit 220 that generates the calendar display 220′ to keep track of planned behavior changing actions. As best illustrated in FIGS. 7 and 8, described in more detail below, the system 200 includes a user interface 400 or 500, respectively, through which the respective user interface suggests actions that the user 110 can accept or reject, and through which the user 110 can inspect the profile 210′ of his or her intention-behavior gap. The profile 210′ is automatically presented to the user 110 through the respective user interface 500 or 600 at periodical times and when the user is continuously underperforming. As illustrated in FIGS. 9 and 11, the user interface 400 or 500 is also used to present questions 212′ to the user 110, targeted at improving the intention-behavior gap profile 210′.

Taking into consideration also FIG. 3, FIGS. 2 and 3 show an electronic coaching system 200 according to various embodiments. The system 200 includes a computing resource 201, client devices 102a, 102b, and a network 104. The computing resource 201 includes a processor 107c and a memory 108c that stores an application 110. The computing resource 201 may be a server, computer, or another device providing computing capability. In some embodiments, the computing resource 201 includes a plurality of computing resources that are arranged, for example, in one or more server banks, computer banks or other arrangements. Further, in some embodiments, the computing resource 201 includes a cloud computing resource, a grid computing resource, or any other distributed computing arrangement. For purposes of convenience, a computing resource is referred to herein in the singular, but it is understood that a plurality of computing resources may be employed in the various arrangements described above instead. Although application is described herein as being a component of computing resource 201, it is also envisioned that application may be a component of either or both of client devices 102a and 102b. The computing resource 201 is defined herein to include dedicated devices.

A client device 102 (e.g., denoted as client devices 102a, 102b) is representative of a plurality of client devices that may be coupled to the network 104. In the embodiment illustrated in FIG. 1, the client device 102a is associated with a subject (i.e., a user, client, coachee). The client device 102a may be configured to communicate with an activity monitor 105, which will be discussed in further detail below. Additionally, or alternatively, the activity monitor 105 may be configured to communicate with the computing resource 101 over the network 104 without a client device 102 as an intermediary. The client device 102b is associated with a coach. Client devices 102 may be configured to receive data from activity monitor 105, or otherwise transmit data between activity monitor 105, client devices 102, and computing resource 101, as will be described in further detail below. Although activity monitor 105 is shown and described as being a separate component, unit, or element, from client device 102, it is also envisioned that client device 102, in particular client device 102a, may be configured to perform all of the functions of activity monitor 105.

A client device 102 may include, for example, a processor-based system such as a computer system. Such a computer system may be embodied in the form of a desktop computer, a laptop computer, a personal digital assistant, a mobile device, a cellular telephone, a smart phone, a set-top box, a music player, a web pad, a tablet computer system, a gaming console, or other devices with like capability. The client device 102 may be configured to execute various applications such as a browser and/or other applications. When executed in a client device 102, the browser may render network pages, such as web pages, on a display device and may perform other functions. The browser may be executed in a client device 102 for example, to access, render, or display network pages, such as web pages, or other network content served up by the computing resource 201 and/or other servers. The client device 102 may be configured to execute applications other than a browser such as, for example, email applications, instant message applications, mobile applications, and/or other applications. The client device 102 may be defined as a dedicated device.

The network 104 includes, for example, the Internet, intranets, extranets, wired networks, wireless networks, wide area networks (WANs), local area networks (LANs), or other suitable networks, etc., or any combination of two or more such networks.

The computing resource 201 and client devices 102 each respectively include a processor 107 and a memory 108. In the embodiment illustrated in FIG. 3, the client device 102a includes a processor 107a and a memory 108a, and the client device 102b includes a processor 107b and a memory 108b. Further, the computing resource 201 includes a processor 107c and a memory 108c. In some embodiments, the computing resource 201 and client device 102 may include more than one processor 107 and more than one memory 108. For purposes of convenience, the processor 107 and memory 108 are referred to herein in the singular, but it is understood that a plurality of processors 107 and/or a plurality of memories 108 may be employed by a computing resource 201 or a client device 102.

Processor 107 is configured to process any of the steps or functions of computing resource 201 and/or system 200, and/or any of the modules, units, or components thereof. The term processor, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

A memory 108 may include both volatile and/or nonvolatile memory and data storage components. Volatile components are those that do not retain data values upon loss of power. Nonvolatile components are those that retain data upon a loss of power. Thus, the memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components.

In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), another like memory device. A memory 108 is a computer readable medium.

Further, a memory 108 may store instructions that are executable by the processor 107. For example, the memory 108c of the computing resource 201 stores instructions for the application for promoting a healthier lifestyle of a subject. The term subject designates the user associated with client device 102a, and this user is the coachee (i.e., the person who is coached by the system 200). This person may also be designated as customer, client, and/or subject in the present text. As referred to herein, the coach is an electronic coach as implemented by the system 200 in FIG. 2. The memory 108c may also include a profile unit 210 includes a plurality of user profiles 210′, as will be described in further detail below.

Each user profile 210′ may be associated with a particular subject and is generated by accessing behavior planning calendar unit 220. The memory 108c further includes a targeted questions unit 212 that may include a collection of standardized questions to be posed to the user that are generated by accessing behavior sensor monitoring unit 230. The memory 108c further includes a suggestions unit that generates suggestions 214′ to the user based on the responses provided by the user via the targeted questions unit 212 for selection by computing resource 201 and/or any components thereof. In conjunction with FIGS. 2 and 3, FIGS. 4A and 4B illustrate a workflow 3000 of the entire electronic coaching system 200. Beginning at Start 3010, step 3012 includes programming the initial profile 210′ of the user 110 into the electronic coach 202 (see FIGS. 2 and 3).

As described in more detail below with respect to FIGS. 5A and 5B, step 3012 is implemented by applying a “squashing factor” to generate an initial profile for the user 110 that is updated as time progresses for the existing coaching service 202′. Current level goal 3016 for the user 110 is retrieved from the memory of existing coaching service 202′ and is input into the electronic coaching system 200 at step 3300 where the current level goal 3016 is modified as necessary in comparison to initial profile 210′ (see FIGS. 2 and 3). The existing coaching service 202′ may include, for example, the Philips DirectLife™ activity monitor manufactured by Koninklijke Philips Electronics, N.V., that is described below with respect to FIG. 14 as dedicated device 700 which functions as a sensor for sensing at least one behavior parameter of the user 110. The current level goal 3016 may be set inside the existing coaching service 202′ and is provided as input to the electronic coaching system 200 at step 3300.

As described in more detail with respect to FIGS. 7 and 8, electronic calendar 220′ is programmed with planned behavior changing actions 3100 and times at which behavior changing actions are planned 3102. The calendar 220′ also includes storage and processing 3102 of the time, predicted location of the user and predicted planned activity, e.g., a meeting, travelling to work, cooking or behavior changing action.

A database of mediating factors 3200 processes and stores factor implication values 3202. The database of mediating factors 3200 also processes and stores current factor values and new factor values 3204.

The user 110 is prompted by the electronic coach 202 for a selection 3020 of his or her profile 210′ for inspection. The user 110 is subsequently prompted by the electronic coach 202 to generate an acceptance or a refusal or rejection 3110 of the planned behavior changing action 3100.

A database of actions 3220 includes processing capability for contribution to the user's goal or goals 3018.

The workflow 3000 continues with step 3300 of comparing the current level of the user's performance to the current level goal 3016. In decision step 3302, it is determined if the current level goal 3016 has been reached. If the goal 3016 has been reached, the workflow 3000 proceeds to step 3304 of stopping the workflow. If the goal 3016 has not been reached, the workflow 3000 proceeds to step 3304 of comparing the current level of the user's performance and the planned behavior changing actions or level 3100 to the current level goal 3016.

In decision step 3306, it is determined if the goal will be reached. If the goal will be reached, the workflow 3000 proceeds to step 3316 of monitoring the user's behavior.

If the goal will not be reached, the workflow 3000 proceeds to step 3308 of suggesting to the user 110 actions to be planned. Step 3308 of suggesting the actions to be planned is more fully described in FIGS. 6A and 6B discussed below.

The workflow 3000 then proceeds to decision step 3310 of determining if the suggested action or actions 3308 have been accepted by the user 110. If the action or actions 3308 have been accepted by the user 110, the workflow 3000 proceeds to step 3312 of planning the suggested action and then to step 3316 of monitoring the user's behavior. The planned behavior changing action 3100 is recorded in the calendar 220′.

If in decision step 3310 it is determined that the user 110 has not accepted the suggested action or actions 3308, the workflow 3000 proceeds to step 3314 of updating the measures as described in detail below. After step 3314 of updating the measures has been completed, the workflow 3000 returns to step 3308 of suggesting to the user 110 actions to be planned.

During step 3316 of monitoring the user's behavior, the workflow 3000 proceeds to decision step 3318 of determining, via the calendar 220′, whether the time or times at which behavior changing actions have been planned 3102 have already passed. If it is determined that the time or times at which behavior changing actions have been planned 3102 have not already passed, the workflow 3000 returns to step 3316 of monitoring the user's behavior.

If it is determined that the time or times at which one or more behavior changing actions have been planned 3102 have already passed, the workflow 3000 proceeds to decision step 3320 of determining whether the planned behavior changing action 3100 has been performed. If it is determined that the planned behavior changing action 3100 has been performed or that the planned behavior changing action 3100 have not been performed, the workflow 3000 proceeds to step 3314′ of updating the measures or actions accordingly as also described in detail below.

Following step 3314′ of updating the measures or actions, the workflow 3000 returns to step 3300 of comparing the current level of the user's performance to the current level goal 3016 at which point the workflow 3000 enters a repeat cycle.

Legenda 300 illustrates that a solid rectangle 302 indicates a system process, a dotted rectangle 304 indicates a complex system process, a diamond 306 indicates a decision and a parallelogram 308 indicates data.

FIGS. 5A and 5B illustrate the detailed implementation of step 3308 of the workflow 3000 of suggesting to the user 110 one or more actions to be planned. The implementation of step 3308 begins with step 3402 of initializing actions to be suggested to the user 110.

As defined herein, an action is a behavior that is in accordance with the intention (so for example “going for a walk” is an action that is in accordance with the intention “becoming more active”).

As defined herein, a gap(action) is the quantified size of the intention-behavior gap for a certain action. According to embodiments of the disclosure, it is intended to find actions with a minimal gap(action). It has been observed in the art that there are certain mediating factors influencing the size of gap(action). These mediating factors are illustrated in TABLE 1 and depend on properties of the individual user, the situation (such as location) (context), and the action itself. These action properties are stored in database 3220 and step 3402 of initializing the actions includes accessing the database 3220.

Once the action properties are initialized in step 3402, they are stored in database 3222.

Since the mediating factors illustrated in TABLE 1 depend on the context, it is actually necessary to calculate gap(action,context) instead of gap(action). Step 3404 includes determining the context of the action, e.g., the location or time of the action. Once the context of the properties has been determined in step 3404, the resulting set of predicted context properties are stored in database 3224. A predicted context property relates to a prediction of what the context will be like at a certain point in time (in the future).

Step 3406 includes combining the set of action properties stored in data base 3222 with the set of predicted context properties stored in database 3224. The set of action properties is stored in data base 3222. the set of predicted context properties is stored in database 3224, Each property has associated with it, a value for each mediating factor. A set of context properties and a set of action properties are stored. The sets are used as input (genes) for the genetic algorithm. Each property (whether it is a context property or an action property) has associated to it, for each mediating factor, a value (this is the mediating factors profile).

However, it is computationally too time-consuming to determine the effect of the mediating factors for each action-context combination for the user. Step 3406 Is thus implemented such that each action as well as each context can be decomposed into a limited set of properties. For example, for physical activity, action can be decomposed into the following:

Type/category (e.g. walking, running, cycling, etc.)

Indoor/outdoor

High/medium/low intensity

Team/solo

Duration

And context can be decomposed into:

Location

Time

Suppose that there are 13 mediating factors (as in TABLE 1); m₁, . . . , m₁₃. Instead of keeping track of the values of m₁(action,context), . . . , m₁₃(action,context) for each action-context pair, the values m₁(property), . . . , m₁₃(property) for each property of either an action or a context are tracked. Now, the size of gap(actionₐ, context_{c}) is calculated by combining the values for each m₁(property), . . . , m₁₃(property) for all properties of actionₐ and context_{c}.

The values of mediating factors m₁(property), . . . , m₁₃(property) can be determined in several ways. In any case, the values for each m(property) are set within the range 0-1, as per step 3402 in FIG. 5A. This can be done by applying a so called ‘squashing function’ such as the sigmoid function (see FIG. 6).

In FIG. 6, the horizontal X axis is the value V of the mediating factors. The vertical axis Y is the sigmoid factor as a function of V, i.e., sigmoid (V). All values m₁(property), . . . , m₁₃(property) are initialized to the value 0.5, so that they all have an equal contribution to start with. These values V are updated during the course of use. For example, suppose that the measures from TABLE 2 result in some value V. In order to scale these measures to the same order of magnitude, so that they can be compared to each other in order to determine which factor has the largest impact, in this example, the sigmoid function may be used. The sigmoid function

$$\frac{1}{1 + {e}^{- sigma ( V - tau )}}$$

converts every value V to a value between 0 and 1, and the result sigmoid (V) versus V is plot 10 in FIG. 6. Sigma determines the slope of the function, and tau is its default value (the value V for which the sigmoid function returns 0.5). The result 10 in FIG. 6 shows an example of the sigmoid function for tau=0 and sigma=1.

Using the sigmoid function with tau=0 results in automatic initialization of the profile; if every value V is initialized to 0, each factor will have the value 0.5 to start with. The user 110 can thus start using the system 200 directly after installing it; he or she will not have to create a profile manually. The system 200 will start with the default profile, which it can adapt to the user's personal situation over time.

Two variations of how the values V might be updated are provided below.
Triggers for updating certain measures of the quantified intention-behavior gap profile are
The user rejects the suggested action(s)
An action was planned at a certain time and this time has passed, the system has measured the user's behavior at this planned time and concludes that
[2a] The planned action has been performed
[2b] The planned action has not been performed

When these triggers occur, the measures are updated (via step 3314 and step 3314′ in FIG. 4B).

More particularly, when trigger 1 and trigger 2b, occur, as described below with respect to FIGS. 9 and 11, drop-down boxes 3600 and 3700, respectively, are shown to the user. When trigger 2a occurs, indicating that the planned action has been performed, values of all mediating factors, e.g., mediating factors 518 in FIG. 8, involved in the action-context combination of the action that was executed by the user are lowered.

Behavior changing actions are proposed in the form of Time×Action pairs. Through context detection/routine detection, a (predicted) location is added to this Time×Action pair. If included in the agenda of the user in such a format, the action represents an implementation intention (an intention to execute some action at a specific time and location) (Sheeran, 2002).

As described above, an action is defined as some combination of properties. For example, a physical activity can be described as a combination of the following properties:

Type/category (e.g. walking, running, cycling, climbing, swimming)

Indoor/outdoor

High/medium/low intense

Team/solo

Duration

A genetic algorithm is used to determine a behavior changing action that has a small intention-behavior gap.

A genetic algorithm is an algorithm which uses the idea of biological evolution for optimization. Biological evolution works as an optimization method, because the fittest individuals survive and reproduce, but also because genetic mutations create variation in the species, which makes them flexible to adapt to changes in the environment.

In a genetic algorithm, individuals are possible solutions to a computational problem. The population of a species is represented by a set of such individuals. A fitness function is defined on individuals, which is used to select individuals for reproduction and for survival. Reproduction is achieved, similar to reproduction in biological evolution, through recombination (also called crossover) of the genes of two (or more) individuals. This means that in order to apply a genetic algorithm to a computational problem, its candidate solutions need to be represented as some combination of elements, or in other words, genes. Mutation on these genes ensures a certain amount of variation in the population.

So for example, a solution to a numerical optimization problem can be represented as a bit-string. The bits in this bit-string are the genes of the individual. Reproduction can be achieved by selecting half of the bits of one individual, and half of the bits of another individual and combining them to create a new individual. Mutation can be achieved by flipping a randomly selected bit of one individual from 0 to 1, or from 1 to 0. A good introduction to genetic algorithms can be found in (Eiben, Smith, 2003).

In order to find behavior-changing actions that have a small intention-behavior gap for a particular user in a particular context, one must consider the following:

(1) Actions that target the desired behavior which are represented as a composition of properties.

(2) The genes in the genetic algorithm which are formed by those properties, as well as the time of day.

(3) The fitness function of the genetic algorithm which is defined as the size of the intention-behavior gap for a particular user-context-action triple.

The size of the intention-behavior gap is defined as the average of the values for each factor in the intention-behavior profile. The values in the profile are determined by taking the average of values for the mediating factors involved in the last few actions that were suggested, rejected, accepted, executed or not executed.

Referring specifically to FIG. 5B, step 3502 then includes running one generation of a genetic algorithm with genes formed by time and action properties. A fitness function is calculated which equals the size of the intention-behavior gap. Crossover is calculated which equals to combining genes of two individuals randomly. Mutation is determined as equal to change in a single gene by (dependent on its type) flipping the value of the gene, increasing/decreasing the value of the gene, choosing a random other value, and other like actions.

In decision step 3504, it is determined whether to continue step 3502 of running one generation of the genetic algorithm. This determination is made by defining a maximum number of generation runs and defining a stop criterion as occurring when differences in the intention-behavior gap size become too small, i.e., when differences in the intention-behavior gap size are less than or equal to a pre-determined value.

If it is determined to continue, implementation of step 3308 of suggesting one or more actions to be planned is effected by returning to step 3502 where running another generation of the genetic algorithm is caused to occur.

If it determined not to continue step 3502, step 3506 is implemented of returning x fittest individuals to step 3308 wherein the x fittest individuals are suggested to the user.

FIG. 7 illustrates a visual display 402 of an electronic calendar 400 in which the electronic calendar 202 of FIG. 3 is designed for the target behavior of increasing physical activity of the user 110 according to one embodiment of the present disclosure. The visual display 402 includes illustrations of the current and next two months 404. The user may select to display the day 406, the week 408 and the month 410. Week 408 is illustrated in the example.

The user may click on the Monday time slot 412 of 12:00-12:30 to schedule a walk. A pop-up 414 appears for the user to schedule the details of the activities. The uppermost selection box 416 indicates “12:00-12:30 Lunchwalk”. The user may then enter the type of activity in selection box 418, e.g., “Type: Walking”, the location of the activity in selection box 420, e.g., “Location: Outside”, the intensity of the activity in the selection box 422, e.g., “Intensity: Medium”, the invited people in selection box 424, e.g., “Invited People: Lu, Aart”; and the estimated number of calories to be burned during the activity in selection box 426, e.g., “Estimated number of calories: 250”.

The electronic calendar 400 thus suggests activities that can be planned. These activities are shown in the agenda, and if the user clicks on the activity, the user sees the entire definition of the activity in terms of all context and action properties.

The user may schedule other physical activities in boxes such as “Cycle Outside” 430 and “Fitness Gym” 434 and non-physical activities such as “Meeting Meetingroom 1” 432 and “Presentation Presentationroom 1” 428. The references to “outside”, “gym” and “meetingroom1” and “presentationroom 1” are exemplary locations where the activities may take place.

FIG. 8 illustrates a visual display 502 of an electronic calendar 500 in which the electronic calendar 202 of FIG. 3 is designed for coaching stress relief to the user 110 according to one exemplary embodiment of the present disclosure. The visual display 502 may include a calendar month 504 in the upper right hand corner. The day of the week 506, e.g., “Thursday” and the date 508 of the day of the week, e.g., “10” may also be displayed in the upper portion of the display 500.

In the lower portion of the display 502, the user's performance 510 may be displayed below the date 508, e.g., “50%” and a suggestion 512 displayed, e.g. an icon of a coffee cup with a written description 512′ of the break description, e.g., “Take a break to get coffee at 13:30 for 10 minutes”. The suggestion 512 is derived from step 3308 of suggesting the action to be planned in FIG. 4B.

To the left of the suggestion icon 512 are located touch screen buttons 514 and 516. By pressing touch screen button 514, the user elects to “Accept” the suggestion 512. Alternatively, by pressing touch screen button 516, the user elects to “Reject” the suggestion 512.

If the user elects to reject the suggestion 512, various mediating factor icons are presented to the user as feedback 518. The mediating factor icons 518 include from left to right icon 520 representing “Anticipated Regret”, icon 522 representing “Conflicting Intentions”, icon 524 representing “Actual and Perceived Behavioral Control”, icon 526 representing “Type of Behavior”, and icon 528 representing “Attitudinal versus Normatively Controlled Intentions”. These icons are meant to indicate the factors which are the most important barriers for this user to this user changing his or her behavior.

In one embodiment, the mediating factor icons 518 include from left to right touch screen icon 520 representing “Anticipated Regret”, touch screen icon 522 representing “Conflicting Intentions”, touch screen icon 524 representing “Actual and Perceived Behavioral Control”, touch screen icon 526 representing “Type of Behavior”, and touch screen icon 528 representing “Attitudinal versus Normatively Controlled Intentions”. As touch screen icons, if the user touches an icon associated with a certain factor, he or she receives more information on this factor, for example tips on how to deal with this factor (e.g. if he or she clicks on the factor behavioral control—material, i.e., icon 524 representing “Actual and Perceived Behavioral Control”, he or she could get a tip to plan certain activities such as swimming the evening before, so that the user remembers and has time to bring a swimsuit).

In conjunction with the visual displays 400 and 500 and the workflow 3000 described above with respect to FIGS. 4A, 4B, 5A and 5B, in the following text, two variations of calculating gap 510 and mediating factors 518, and three embodiments are described.

According to one exemplary embodiment of the present disclosure, an alternative method of performing step 3502 of calculating the fitness function which equals the size of the intention-behavior gap is by calculating the gap size through the products of the properties of the actions and the properties of the contexts. That is, suppose actions have 5 properties: Paction1, . . . , Paction5 and contexts have 3 properties: Pcontext1, Pcontext2, Pcontext3 and there are 13 mediating factors: m1, . . . , m13

Then gap (a,c) for action a and context c is calculated as follows:

gap(a,c)=m₁(P_{action1}(a))·□·m₁₃(P_{action1}(a))·

m₁(P_{action2}(a))·□·m₁₃(P_{action2}(a))·

m₁(P_{action3}(a))·□·m₁₃(P_{action3}(a))·

m₁(P_{action4}(a))· . . . ·m₁₃(P_{action4}(a))·

m₁(P_{action5}(a))·□·m₁₃(P_{action5}(a))·

m₁(P_{context1}(c))·□·m₁₃(P_{context1}(c))·

m₁(P_{context2}(c))·□·m₁₃(P_{context2}(c))·

m₁(P_{context3}(c))·□·m₁₃(P_{context3}(c))

According to one exemplary embodiment of the present disclosure, another alternative method of performing step 3502 of calculating the fitness function which equals the size of the intention-behavior gap is by calculating the gap size through the average of the products. That is, suppose actions have 5 properties:

P_{action1}, . . . , P_{action5}

and contexts have 3 properties:

P_{context1}, P_{context2}, P_{context3}

and there are 13 mediating factors: m₁, . . . , m₁₃

Gap (a,c) for action a and context c is then calculated as follows:

gap(a,c)=[P₁action1(a))·□·m₁13(P₁aciton1(a))+

m₁(P_{action2}(a))·□·m₁₃(P_{action2}(a))+

m₁(P_{action3}(a))·□·m₁₃(P_{action3}(a))+

m₁(P_{action4}(a))·□·m₁₃(P_{action4}(a))+

m₁(P_{action5}(a))·□·m₁₃(P_{action5}(a))+

m₁(P_{context1}(c))·□·m₁₃(P_{context1}(c))+

m₁(P_{context2}(c))·□·m₁₃(P_{context2}(c))+

m₁1(P₁context3(c))· . . . ·m₁13(P₁context3(c))]/(5+3)

Another exemplary method of performing steps 3012, 3300 and 3304 of calculating the mediating factors to implement step 3314 of updating the measures in FIG. 4A by user feedback according to one exemplary embodiment of the present disclosure is as follows. Suppose actions have 5 properties:

P_{action1}, . . . , P_{action5}

and contexts have 3 properties:

P_{context1}, P_{context2}, P_{context3}

and there are 13 mediating factors: m₁, . . . , m₁₃ constituting the 13 factors listed in TABLE 1.

For each action a and each context c, initialize m₁(P_{action1}(a)) . . . m₁₃(P_{action1}(a)), . . . , m₁(P_{action5}(a)) . . . m₁₃(P_{action5}(a)) and m₁(P_{context1}(c)) . . . m₁₃(P_{context1}(c)), . . . , m₁(P_{context3}(c)) . . . m₁₃(P_{context3}(c)) to 0.5.

Do action-context suggestions to the user. A user can choose to accept or reject to plan the suggestion in their calendar 220′ and 512 (see FIGS. 2 and 8).

In FIG. 4B, step 3310, when an action suggestion is accepted, such as by the user 110 pressing the accept button 514 for a suggestion 512 in FIG. 8, lower all the values of m₁(P_{action1}(a)) . . . m₁₃(P_{action1}(a)), . . . , m₁₃(P_{action1}(a)), . . . , m₁(P_{action5}(a)) . . . m₁₃(P_{action5}(a)) and m₁(P_{context1}(c)) . . . m₁₃(P_{context1}(c)), . . . , m₁(P_{context3}(c)) . . . m₁₃(P_{context3}(c)) for that particular action-context combination.

Also in step 3310, referring to FIG. 9, when an action suggestion is rejected, such as by the user 110 pressing the reject button 516 in FIG. 8, via a prompt 3600 in display 400 or 500, ask “Why do you not want to plan this suggestion?” and provide the following options through a drop-down box 3610:

I don't feel motivated (3612)

It does not fit me (3614)

Don't feel capable (3616)

Doesn't contribute much to my goal (3618)

Don't know how to do it (3620)

Instructions are not clear to me (3622)

I expect I will not be able to do this (3624)

Referring to FIG. 10, step 3650 is implemented dependent on which option the user selects, of increasing the value of a certain mediating factor:

I don't feel motivated (3612)=>degree of intention formation (3652)

It does not fit me (3614)=>self-schema (3654)

Don't feel capable (3616)=>confidence (3656)

Doesn't contribute much to my goal (3618)=>anticipated regret (3658)

Don't know how to do it (3620)=>behavioral control (3660)

Instructions are not clear to me (3622)=>concreteness of type of action (3662)

I expect I will not be able to do this (3624)=>expectations (3664)

In FIG. 4B, step 3312, when an action is planned, it can be measured whether it was executed or not.

When a planned action is executed, lower all the values of m₁(P_{action1}(a)) . . . m₁₃(P_{action1}(a)), . . . , m₁(P_{action5}(a)) . . . m₁₃(P_{action5}(a)) and m₁(P_{context1}(c)) . . . m₁₃(P_{context1}(c)), . . . , m₁(P_{context3}(c)) . . . m₁₃(P_{context3}(c)) for that particular action-context combination.

In step 3312, referring to FIG. 11, when a planned action has not been executed, via a prompt 3700 in display 400 or 500, ask “Why did you not do this activity?” and provide the following options through a drop-down box 3710:

I did another activity (3712)

Other important things to do (3714)

Did not feel capable (3716)

I forgot (3718)

Did not know how to do it (3720)

Instructions were not clear to me (3722)

Something unexpected came up (3724)

Referring to FIG. 12, step 3750 is implemented dependent on which option the user selects, of increasing the value of a certain mediating factor:
I did another activity (3712)=>action versus state oriented personality (3752) (this value should actually be decreased, because it makes the user a more action oriented person, which is better in terms of trying to achieve a behavior change)
Other important things to do (3714)=>temporal stability, conflicting intentions (3754)
Did not feel capable (3716)=>confidence (3756)
I forgot (3718)=>accessibility (3758)
Did not know how to do it (3720)=>behavioral control (3760)
Instructions were not clear to me (3722)=>concreteness of type of action (3762)
Something unexpected came up (3724)=>behavioral control (3764)

In one exemplary embodiment of the electronic coaching system 200, the mediating factors of TABLE 1 are each linked to some measurable behavior without relying on input from the user. By measuring this behavior, the mediating factor may then be automatically tracked. As an example, consider the mediating factor action oriented versus state oriented personality.

Action oriented people have a greater tendency to focus on the actions required to reduce the gap between their current state and the desired state, while state oriented people only focus on their current state or the intended state. Action oriented people are therefore more flexible in considering alternative ways to reach a goal, state oriented people are not able to consider alternatives since they only focus on one of the two states.

The user is using a calendar, e.g., electronic calendar 400 or 500 in FIGS. 7 and 8, respectively, to plan activities and he or she is using a sensor to measure his or her actual behavior. How many times a planned action is executed and how many times it was not executed but an alternative action was executed (e.g. the user did not go for the planned lunch-walk, but instead got on his or her bike to cycle from one location to the other during lunch) can be tracked. Suppose the number of times that a planned action was not executed (either because no action was executed, or because an alternative action was executed) is x and the number of times an alternative action was executed is y. Then the value for this mediating factor may be measured by a calculation such as 1−y/x. This value will become smaller when y is larger, so that the impact of the mediating factor becomes smaller when a person has a more action oriented personality.

The mediating factors are listed in TABLE 2 following and appear as icons 518 as described above with respect to FIG. 8 above. Since the factors from TABLE 1 can not directly be measured, measurable indicators for these factors need to be found as identified in TABLE 2.

TABLE 2
MEASURABLE INDICATORS FOR THE FACTORS
INFLUENCING THE INTENTION-BEHAVIOR GAP

| Mediating Factor | Measure |
|---|---|
| Degree of | Ask the user “Why do you want to change your |
| intention | behavior?” |
| formation | The actual answer can be analyzed in order to |
| | obtain a value for the strength of the intention. Also, |
| | the degree of detail (measured e.g. through the |
| | number of words used) in the answer can provide a |
| | clue for the strength of the intention (how much is it |
| | thought through). |
| Action | Keep track of how many times planned actions are |
| oriented | executed, and how many times, when an action was |
| versus state | not executed, an alternative action was executed at |
| oriented | the time of the planned action. |
| personality | |
| Temporal | Keep track of how many times the user changes his |
| stability | or her answer to the question “Why do you want to |
| | change your behavior?”. |
| | When a planned action is not executed, ask the user |
| | “Why did you not do this action?” and analyze the |
| | answer. Answers like: “I had other, more important |
| | things to do”, indicate a low temporal stability of the |
| | intention. |
| Self-schemas | Let the user indicate preferences. Keep track of how |
| | many times certain actions are executed. The more |
| | they are executed, the better the user will think the |
| | action fits for him. |
| Confidence | Ask the user: “How capable are you to do this?” |
| | Keep track of how many times certain (types of) |
| | actions are executed. The more they are executed, |
| | the more capable the user will be, and the more |
| | confident he or she will probably feel. |
| Accessibility | Keep track of how many times the user looks at (a |
| | planned action in) his or her calendar. |
| Anticipated | Ask the user “How much do you think this action |
| regret | contributes to your goal?” and/or “How much do you |
| | think this action contributes to your personal reason |
| | for changing your behavior?” |
| | Analyze the answer(s) |
| Behavioral | Ask the user: “How capable are you to do this?” |
| control: | Keep track of how many times certain (types of) |
| knowledge, | actions are executed. The more they are executed, |
| ability | the more capable the user will be in terms of the |
| (user-action | necessary knowledge and ability for this action. |
| side) | Use an expert or a machine learning algorithm on a |
| | large set of users to determine how much certain |
| | actions depend on a specific ability or on specific |
| | knowledge of the user. |
| | Compare the user indicated knowledge and ability |
| | for this action to the knowledge and ability required |
| | for the action as measured through experts or |
| | machine learning. |
| Type of | Let experts or a large set of users indicate how clear |
| action | and concrete the instructions for a specific action |
| | are. |
| | Ask the user: “Are the instructions for this action |
| | clear to you?” |
| | If the answer is “yes”, the value for this factor can be |
| | increased, if it is “no”, the value should be |
| | decreased. |
| Implementation | Keep track of how many times a certain (type of) |
| intentions | action is executed by the user in a certain (type of) |
| | context? |
| | As the number of times it is executed in a certain |
| | context increases, the value for implementation |
| | intentions for this action in this context increases. |
| Behavioral | Keep track of the user's location, the time of day and |
| control: | his or her agenda for the day, to see how busy the |
| (mental) | user is (mental resources, opportunity), if others |
| resources, | may be available to team up with (cooperation), how |
| opportunity, | likely it is that certain equipment is available at the |
| availability | current location (availability of materials), etc. |
| of materials, | Possibly, certain equipment that is necessary to |
| cooperation | execute a certain action can even carry an RFID |
| (action- | tag, so that its availability at a certain location can |
| context side) | be determined. |
| Behavioral | Keep track of changes the user makes to his or her |
| control: | calendar during the day, keep track of deviations |
| Unexpected | from the user's normal routine throughout the day, |
| situations | keep track of specific things which may form |
| (context-side) | unexpected situations for the targeted behavior (e.g. |
| | physical activity may be hindered by bad weather). |
| Attitudinal | Analyze the answer to the question “Why do you |
| versus | want to change your behavior?” in terms of to what |
| normative | extent the user's reasons are self-initiated and to |
| | what extent they are initiated by others (e.g. “My |
| | doctor says I should . . . ”). |
| Conflicting | Besides behavior changing actions, the user should |
| intentions | also be able to plan other activities in his or her |
| | electronic calendar. If another activity is planned |
| | which overlaps with a planned behavior changing |
| | action and this behavior changing action is then not |
| | executed, the value for conflicting intentions should |
| | be increased. If the action is executed, the value |
| | should be decreased. |
| | In addition, after not executing a planned action, the |
| | user can be asked to indicate a reason for not |
| | executing this action. If a reason is indicated, it can |
| | be analyzed and if it indicates conflicting intentions, |
| | the value can be increased. |
| Expectations | After including a behavior changing action in the |
| | electronic calendar, ask the user “Are there factors |
| | that make you suspect that you may be |
| | unsuccessful in executing this action?” |
| | Analyze the answer. |

As described above with respect to FIG. 6, suppose that the measures from TABLE 2 result in some value V. In order to scale these measures to the same order of magnitude, so that they can be compared to each other in order to determine which factor has the largest impact, the sigmoid function is one example of a squashing function that may be used. The sigmoid function

$$\frac{1}{1 + {e}^{- sigma ( V - tau )}}$$

converts every value V to a value between 0 and 1. Sigma determines the slope of the function, and tau is its default value (the value V for which the sigmoid function returns 0.5). As described above, FIG. 6 shows an example of the sigmoid function for tau=0 and sigma=1.

As can be appreciated from the foregoing description, an embodiment of the present disclosure is a coaching system for physical activity. The Philips DirectLife Activity Monitor™ can be used to measure the target behavior. The target behavior consists of an increased physical activity level in terms of caloric expenditure. The goal will be a number of calories to expend over the day. The behavior changing actions that can be planned are actions that require physical activity, such as walking, cycling, all kinds of sports, or even household activities. They could for example be composed of the following properties:

Type/category (e.g. walking, running, cycling, climbing, swimming)

Indoor/outdoor

High/medium/low intense

Team/solo

Duration

An example of what the electronic calendar may look like can be seen in FIGS. 7 and 8 as described above.

Other devices can be used to obtain information about the user's context, such as a global positioning system (GPS) in a smart phone for obtaining his or her location, detection of the number of keystrokes on a personal computer (PC) for detection of how busy the user is, a heart rate and or galvanic skin response (GSR) monitor for detection of the level of stress, etc.

In one exemplary embodiment, referring now to FIG. 13, there is illustrated user 1101 wherein the user 1101 is carrying a user interface exemplified by smartphone 600. The smartphone 600 includes at least one sensor for sensing location and activity of the user 1101, e.g., smartphone 600 may include an accelerometer 602 disposed either externally or internally within the smartphone. Via a global positioning system (GPS) 604, the GPS 604 and accelerometer 602 may be used to measure the behavior and location of the user 1101. The electronic calendar 400 of FIG. 7 or the electronic calendar 500 of FIG. 8 may be applied to visual display 606 of the smartphone 600 in order to plan for the user 110a activity suggestions such as pop-up 414 in FIG. 7 or suggestion 512 in FIG. 8. Through a user interface such as the smartphone keyboard or touchscreen on the visual display 606, the user 1101 can view activity suggestions and can accept or reject them, such as via touch screen buttons 514 and 516, respectively, as described above with respect to FIG. 8. An application stored in the processor of the smartphone 600, that is part of the client device 202b in FIG. 3, can retrieve the planned activities, such as pop-up 414 in FIG. 7 or suggestion 512 in FIG. 8, and at the time of a planned activity, the application can measure whether the user 1101 is doing the activity (e.g. when the user 1101 has planned a walk, the accelerometer 602, in conjunction with the GPS 604, can be used to verify whether the user 1101 is walking, when the user 1101 has planned to go swimming, GPS 604 can be used to verify whether the user 1101 is at a swimming pool 608). An extra user interface 610 can be added to the application such that the user 1101 can view his or her intention-behavior gap profile 210′ and 210 in FIGS. 2 and 3 respectively.

In one exemplary embodiment, FIG. 14 illustrates a dedicated device 700 to measure user behavior, such as an activity monitor. One example of the dedicated device 700 that may be used is the Philips DirectLife™ activity monitor manufactured by Koninklijke Philips Electronics, N.V, and which functions as a sensor for sensing at least one behavior parameter of the user (the user is not shown). The dedicated device 700 can be connected to a PC 710 either wirelessly or via a hard-wire connection 716. An application 712 (e.g., a web application) on the PC 710 is used to provide and to plan activities and suggestions of activities which can be accepted or rejected, for example, activity suggestions such as pop-up 414 in FIG. 7 or suggestion 512 in FIG. 8 that can be accepted or rejected, such as via touch screen buttons 514 and 516, respectively, as described above with respect to FIG. 8. When the dedicated device 700 is synchronized with the application 712 on the PC 710, the dedicated device 700 becomes aware of the user's calendar, e.g., electronic calendar 400 of FIG. 7 or the electronic calendar 500 of FIG. 8. The device 700 can remind the user of a planned activity e.g. by buzzing 15 minutes in advance and by showing a summary or the name of the activity on a small screen 702. The dedicated device 700 can then measure whether the activity was executed, e.g., step 3320 in FIG. 4B. Once the dedicated device 700 is synchronized again with the application 712 on the PC 710, the application 712 on the PC 710 can update the mediating factors accordingly, e.g., exemplary mediating factors 518 in FIG. 8 that are derived from TABLE 1 and TABLE 2 and provide new suggestions, e.g., exemplary suggestion 512 in FIG. 8. An extra user interface 714 can be added to the application 712 on the PC 710 such that the user can view his or her intention-behavior gap profile 210′ and 210 in FIGS. 2 and 3 respectively.

In one exemplary embodiment, FIG. 15 illustrates a user 1102 who has at least one sensor 810 to measure behavior. The one or more sensors 810 are disposed on the body of the user 1102 on a garment worn by the user 1102, e.g. sensor 810 is integrated into a piece of clothing 812. The sensor 810 integrated into a piece of clothing 812 may be, for example, an accelerometer in a shoe. A dedicated device 800 communicates with the sensor via near field communications (NFC) or Bluetooth 814 to sense at least one behavior parameter, e.g. such as whether the user 1102 is walking, running or at rest, etc. This device 800 has an interface 802 which shows a calendar, e.g., electronic calendar 400 of FIG. 7 or the electronic calendar 500 of FIG. 8, to plan activities and suggestions of activities which can be accepted or rejected, for example, activity suggestions such as pop-up 414 in FIG. 7 or suggestion 512 in FIG. 8 that can be accepted or rejected, such as via touch screen buttons 514 and 516, respectively, as described above with respect to FIG. 8, or (possibly via gesture control, such as by a particular movement of the user's arm or leg. Reminders for activities can be given e.g. through vibration in the shoe 812. An extra user interface 802, e.g. on the smartphone, or a PC (not shown), or a television (not shown) can be added to the application on the dedicated device 800 such that the user 110b can view his or her intention-behavior gap profile 210′ and 210 in FIGS. 2 and 3 respectively

Other target behaviors for which the system 200 and workflow method 3000 for increasing the likelihood of inducing behavior change in a lifestyle management program according to the embodiments of the present disclosure may be used are:
Healthy eating
Medicine intake
Sleep behavior
Stress relief
Smoking cessation
Light therapy for people suffering from depression
Rehabilitation exercises that should be done at home, e.g. prescribed by a physical therapist
Balancing financial expenses

The system 200 and workflow method 3000 for increasing the likelihood of inducing behavior change in a lifestyle management program according to the embodiments of the present disclosure can be used for coaching behavior change on any dimension for which:
The intended behavior change can be implemented only by a limited set of actions (e.g. smoking cessation can be obtained only by not smoking at times when you would usually smoke).

The intended behavior change can be implemented by actions which can be decomposed into a finite number of parts (as in the example of coaching on physical activity).

For the example of coaching on physical activity, integration with an activity monitor such as the DirectLife service as described above with respect to FIG. 14 may be implemented such that the software for the suggestion and planning of specific physical activities can be a stand-alone application, or the software can be integrated with the DirectLife docking application or as a part of the web application. The software can also be an assistant tool for DirectLife human coaches, which presents to the human coaches the quantified intention-behavior gap for the user and allows the human coaches to articulate to the user tailored suggestions more efficiently. In the food domain, the system 200 and workflow method 3000 for increasing the likelihood of inducing behavior change in a lifestyle management program according to the embodiments of the present disclosure can be integrated with an electronic cooking coach such as My Cooking Companion, manufactured by Koninklijke Philips Electronics, N.V, wherein healthy recipes are recommended to users.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

The following documents are incorporated herein by reference in their entirety:
[1] Edwin A. Locke and Gary P. Latham., Building a Practically Useful Theory of Goal Setting and Task Motivation. American Psychologist, Vol 57(9), September 2002, 705-717.
[2] Paschal Sheeran, Intention-behavior Relations: A Conceptual and Empirical Review, European Review of Social Psychology, Vol 12, 2002.
[3] Fogg, B. J., 2003, Persuasive Technology: Using Computers to Change what We Think and Do. Morgan Kaufmann.
[4] IJsselsteijn, W. et al, 2006, Persuasive Technology for Human Well-Begin: Setting the Scene, Persuasive 2006, LNCS 3962, pp 1-5, Springer-Verlag Berlin Heidelberg.
[5] Lacroix, J. et al, 2009, Understanding user cognitions to guide the tailoring of persuasive technology-based physical activity interventions, Proceedings of the 4th International Conference on Persuasive Technology (Persuasive '09). Article 9, ACM, New York.
[6] Locke, E. A., Latham, G. P., 2002, Building a Practically Useful Theory of Goal Setting and Task Motivation: A 35-Year Odyssey, American Psychologist, Vol 57 (9), pp. 705-717.
[7] Eiben, A. E. and Smith, J. E., 2003, Introduction to Evolutionary Computing, Springer-Verlag Berlin Heidelberg.
[8] Cobiac L. J., Vos T, Barendregt J J, 2009, Cost-Effectiveness of Interventions to Promote Physical Activity: A Modelling Study, PLoS Med, 6(7):e1000110.

What is claimed is:

1. An apparatus for increasing the likelihood of inducing behavior change in a lifestyle management program for a user comprising:
a processor; and
a memory storing instructions, executable by the processor, wherein the instructions when executed by the processor cause the apparatus to:
sense at least one behavior parameter of a user;
identity at least one intention-behavior gap based on the sensing of the at least one behavior parameter;
generate a quantified profile of the at least one intention-behavior gap of the user;
via a user interface, suggest to the user at least one action that the user can accept or reject; and
vary the quantified profile based on the at least one action accepted or rejected by the user.

2. The apparatus according to claim 1, wherein the instructions when executed by the processor further cause the apparatus to:
enable the user to inspect the quantified profile of the intention-behavior gap of the user.

3. The apparatus according to claim 1, wherein the instructions when executed by the processor further cause the apparatus to:
upon sensing the at least one behavior parameter of the user, register the time of the sensing; and
determine whether the at least one behavior parameter has been satisfactorily addressed by the user.

4. The apparatus according to claim 3, wherein the instructions when executed by the processor further cause the apparatus to:
upon determining that the at least one behavior parameter has not been satisfactorily addressed by the user, notify the user, at a time later than the time previously registered, that the at least one behavior parameter has not been satisfactorily addressed, wherein the time later than the time previously registered is a time of a higher likelihood that the user will satisfactorily address the at least one behavior parameter.

5. The apparatus according to claim 4, wherein the instructions when executed by the processor further cause the apparatus to:
follow the notifying of the user at the time later than the time previously registered, determining whether the at least one behavior parameter has been rejected by the user; and
via the user interface, posing to the user at least one question to which the response by the user enables improvement of the quantified profile.

6. The apparatus according to claim 5, wherein the instructions when executed by the processor further cause the apparatus to:
analyze the response by the user to the at least one question.

7. The apparatus according to claim 1, wherein the instructions when executed by the processor further cause the apparatus to:
represent the quantified profile as a combination of properties as either an action or a context or a combination of an action and a context.

8. The apparatus according to claim 7, wherein the instructions when executed by the processor further cause the apparatus to:
apply a genetic algorithm to run at least one generation of the genetic algorithm as genes wherein the timeslot and properties of the action are equivalent to the genes.

9. The apparatus according to claim 8, wherein the instructions when executed by the processor further cause the apparatus to:
define a fitness function as the size of the intention-behavior gap based on the quantified profile.

10. The apparatus according to claim 9, wherein the instructions when executed by the processor further cause the apparatus to:
define a mutation as a change in a single gene by one of flipping the value of the single gene or by increasing the value of the single gene or by decreasing the value of the single gene or by choosing a random other value of the single gene.

11. The apparatus according to claim 10, wherein the instructions when executed by the processor further cause the apparatus to:
define a maximum number of runs of the at least one run; and
define a stop criterion for the running of the at least one generation of the genetic algorithm as stopping the running when differences in the behavior-intention gap are less than or equal to a pre-determined value.

12. The apparatus according to claim 11, wherein the instructions when executed by the processor further cause the apparatus to:
upon the differences in the behavior-intention gap being less than or equal to a pre-determined value,
stop the running of the at least one generation of the genetic algorithm; and
return the top actions of fittest individuals as suggestions to the user.

13. The apparatus according to claim 11, wherein the instructions when executed by the processor further cause the apparatus to:
upon the differences in the behavior-intention gap being greater than a pre-determined value,
return to apply the genetic algorithm to run at least one generation of the genetic algorithm as genes wherein the timeslot and properties of the action are equivalent to the genes.

14. A non-transitory computer readable storage medium storing a program which, when executed by a computer, causes the computer to perform a method for increasing the likelihood of inducing behavior change in a lifestyle management program for a user, comprising:
sensing at least one behavior parameter of a user;
identifying at least one intention-behavior gap based on the sensing of the at least one behavior parameter;
generating a quantified profile of the at least one intention-behavior gap of the user;
via a user interface, suggesting to the user at least one action that the user can accept or reject; and
varying the quantified profile based on the at least one action accepted or rejected by the user.

15. The non-transitory computer readable storage medium according to claim 14 storing a program which, when executed by a computer, causes the computer to perform a method for increasing the likelihood of inducing behavior change in a lifestyle management program for a user, further comprising:
enabling the user to inspect the quantified profile of the intention-behavior gap of the user.
